(19) United States
(12) Patent Application Publication
(10) Pub. No.: US 2009/0222317 A1
(43) Pub. Date: Sep. 3, 2009

(54) SYSTEMS AND METHODS FOR GENERATING ELECTRONIC UPSELL DIRECTORY

(76) Inventors: Tim Allen, Raleigh, NC (US); John R. Mattox, Raleigh, NC (US); Darryl L. Pierce, Raleigh, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 12/040,109

(22) Filed: Feb. 29, 2008

(51) Int. Cl. G06Q 10/00

(52) U.S. Cl. 705/10

(57) ABSTRACT

Embodiments relate to systems and methods for generating an electronic upsell directory A main networked store can communicate with a set of affiliate sites, each of which offers distinct products or services from individualized affiliate catalogs. The affiliate catalogs are each based on a core catalog available from the main store. When a user initiates a purchase transaction at an affiliate site, a transaction profile is transmitted to the main store. The main store examines the transaction profile to match purchased items against an upsell table containing the catalogs of not just the affiliate site conducting the transaction, but the entire set of affiliate sites. Products or services that form suitable options to the user's selected purchase can be aggregated across the affiliate sites and associated catalogs, and presented in an upsell dialog to the user. The user can thereby select upgrades or options from a broader array of sources.

### FIELD

The present invention relates to electronic commerce, and more particularly to platforms and techniques for automatically generating an electronic upsell directory based on a set of multiple catalogs, to present to a user making a purchase.

### BACKGROUND OF RELATED ART

It is known in the electronic commerce arts to provide a Web site that is affiliated or linked to a main store. In known implementations, a user can initiate a purchase transaction at the affiliate site, and complete the transaction in conjunction with the main store. The affiliate site can offer items for sale from a product catalog, which can be based on a set of product selections extracted from the main store. Product selections and comparisons may for example be executed at the affiliate site based on the affiliate catalog, while purchase checkout and shipment selections can be made at the main store, or a feed or link from the main store to the affiliate site.

In further known implementations, the affiliate site or main store can generate a recommendation for additional purchases or options, based on the user's purchase basket. In such implementations, the upsell suggestions are generally based on related products drawn from the affiliate site's product catalog, but not on other sources. In some instances, however, the user might be interested in or benefit from additional products or services from the catalogs of other affiliate sites that are not involved in the immediate transaction. For example, a user making a purchase of an automobile engine part may wish to consider after-market parts or upgrades or services in their area, but those services may be hosted in a different catalog at a different affiliate site. It may be desirable to provide methods and systems for generating an electronic upsell directory that automatically populates the set of upsell recommendations with products or services from multiple affiliate sites.

### DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an overall networked system for generating an electronic upsell directory, according to various embodiments of the present teachings;

FIG. 2 illustrates further aspects of a networked system for generating an electronic upsell directory, according to various embodiments;

FIG. 3 illustrates an exemplary hardware configuration of a main store that can be used in overall networked systems for generating an electronic upsell directory, according to various embodiments; and

FIG. 4 illustrates a flowchart of overall transaction processing in connection with generating an electronic upsell directory, according to various embodiments.

### DESCRIPTION OF EMBODIMENTS

Embodiments of the present teachings relate to systems and methods for generating an electronic upsell directory. More particularly, embodiments relate to platforms and techniques for managing user transactions at one or more affiliate Web sites which in turn communicate with a main network store. The main store can, for example, be a software distributor or hardware vendor. The set of affiliates communicate with the main store via an active link. The active link permits the affiliates to receive content from the main store, such as a selection of an inventory of products and/or services to sell.

In embodiments, each affiliate can thereby build a customized catalog of products to offer in their particular storefront or site. In embodiments, an affiliate's specialized catalog can be augmented with additional products and/or services independently provided by that affiliate. The affiliate's particular catalog can be a subset of the inventory of the main store, for instance representing a set of niche or targeted products/services designed to attract particular users or address particular market segments. In other embodiments, the affiliate catalog can reflect a comparatively larger selection of products/services drawn from the main store. The active link between the set of affiliates and main store further permits the exchange of information and catalog configurations on a dynamic, two-way basis rather than a one-way delivery of catalog information from the main store to affiliate sites.

The main store can host a transaction engine and receive the transaction profile of purchases that are initiated at any of the set of affiliates. The transaction profile contains an identification of the products and/or services being purchased by a given user at an affiliate site. The transaction engine of the main store examines the transaction profile to extract product and/or service IDs, and to generate an upsell directory containing suggested or recommended additional products that the user may wish to consider along with their purchased items. The transaction engine can search for products and/or service IDs in an upsell table. The upsell table contains product and/or service IDs available from the main store and/or individual affiliate storefronts.

The upsell table stores a set of upsell recommendations associated with each product and/or service ID. According to embodiments, the set of upsell recommendations are drawn from more than one affiliate catalog in the set of affiliates. The upsell directory generated for each transaction therefore automatically contains potential product or service purchases aggregated across multiple catalogs. The user can select one or more recommended products or services to add to their transaction based on the combined upsell directory. For instance, a user purchasing a printer from an affiliate specializing for instance in hardware can be presented with upsell options such as printer cartridges from the same or other affiliate, software drivers or other software packages for printers or client computers available from the same or another affiliate, as well as warranty services from the same or another affiliate. The breadth of products and services a user may not be aware of, but wish to consider as part of their purchase, can therefore be expanded by aggregating multiple available affiliate catalogs. These and other embodiments described herein address the various noted shortcomings in known software distribution technology, and provide an enhanced set of marketing opportunities and purchase selections for the user.

Reference will now be made in detail to exemplary embodiments of the invention, which are illustrated in the accompanying drawings. Where possible the same reference numbers will be used throughout the drawings to refer to the same or like parts.

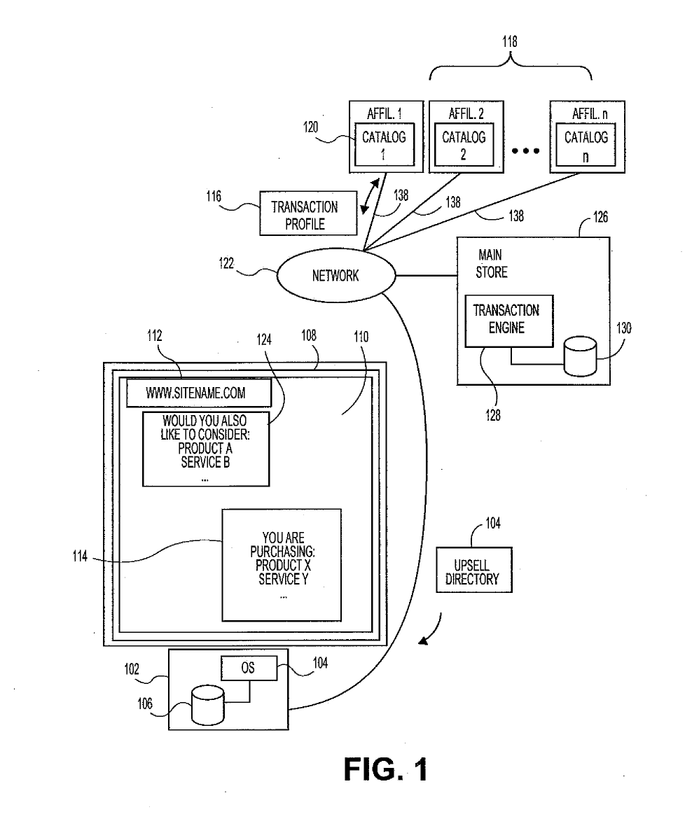

FIG. 1 illustrates an overall system 100 consistent with various embodiments of systems and methods for generating an electronic upsell directory, according to the present teachings. In embodiments as shown, a user can operate a browser 110 on a client 102 to navigate or browse to one or more affiliates in a set of affiliates 118 via a network 122. Browser 110 can be a Web browser, such as the Firefox™, Opera™, or other open-source or proprietary browser application. Each affiliate can be identified by a uniform resource locator (URL) 110, which can be in http://www.sitename.com format under the hyper text transfer protocol (http). In embodiments, other types or formats of site addressing or identification can be used. Network 122 can be or include the Internet, or other public or private networks. Each affiliate in the set of affiliates 118 can be hosted by a site server, such as a Web server.

Client 102 can host and run under control of an operating system 104, such as a distribution of the Linux™ operating system, the Unix™ operating system, or other open-source or proprietary operating system. Client 102 can present a user interface 106, such as a graphical user interface, to the user via operating system 104. Client 102 can contain or access resources including a data store 106, such as a local database stored on a hard drive.

In general, the user operates browser 110 to browse or navigate to one or more affiliates in the set of affiliates 118. The set of affiliates 118 can comprise a set of Web sites or other network locations configured to perform transactions. Each affiliate hosts a respective affiliate catalog 120. Affiliate catalog 120 contains a set of products and/or services available for sale, subscription, or other transactions at the respective affiliate site. Affiliate catalog 120 can include, for instance, hardware products, software products, or services available from the corresponding affiliate. An affiliate can for instance be an independent software vendor (ISV), or other distributor, vendor, or entity.

Each affiliate in the set of affiliates 118 communicates with a main store 126 via an active link 138. Main store 126 maintains a main data store 130 containing an overall set of products and/or services that can be selected by or presented through an affiliate of main store 126 to a user. The affiliate catalog 120,of each affiliate can be built from selections from the main data store 130 using active link 138. In embodiments, individual affiliates may add further products and/or services of their own or from other sources.

Active link 138 can be a two-way connection between affiliates in the set of affiliates 118 and main store 126 through which data, services, and logical control of transaction activities can be shared. Each affiliate can present their respective affiliate catalog 120 through a storefront that directly links to main store 126 through active link 138. Active link 138 can, for example, permit the realtime updating of product and/or service selections, inventory, and other transaction activity conducted via the set of affiliates 118.

According to embodiments, a user can use transaction dialog 114 on client 102 to select one or more products and/or services for purchase, subscription, or other transaction activity at an affiliate in the set of affiliates 118 based on the associated affiliate catalog 120. The participating affiliate can receive and/or generate a transaction profile 116 recording the products and/or services selected for the particular purchase. Transaction profile 116 can record product/service IDs, user and affiliate information, transaction date and time, currency and tax information, and other data associated with the user's initiated transaction. The affiliate transmits the transaction profile 116 to main store 126 via active link 138.

Main store 126 receives transaction profile 116 and transmits that profile to a transaction engine 128. Transaction engine 128 processes transaction profile 116 and generates an upsell directory 140 to transmit back to the client 102. Upsell directory 140 comprises a set of additional products and/or services matched to the user's selected products and/or services in transaction profile 116 as optional further purchases by the user. The possible further products and/or services drawn from the upsell directory 140 can be presented to the user via an upsell dialog 124 on client 102 for consideration. In general, upsell directory 140 and corresponding selections in upsell dialog 124 is not limited to products/services extracted from the affiliate catalog 120 through which the transaction is initiated, but from all participating affiliates in the set of affiliates 118.

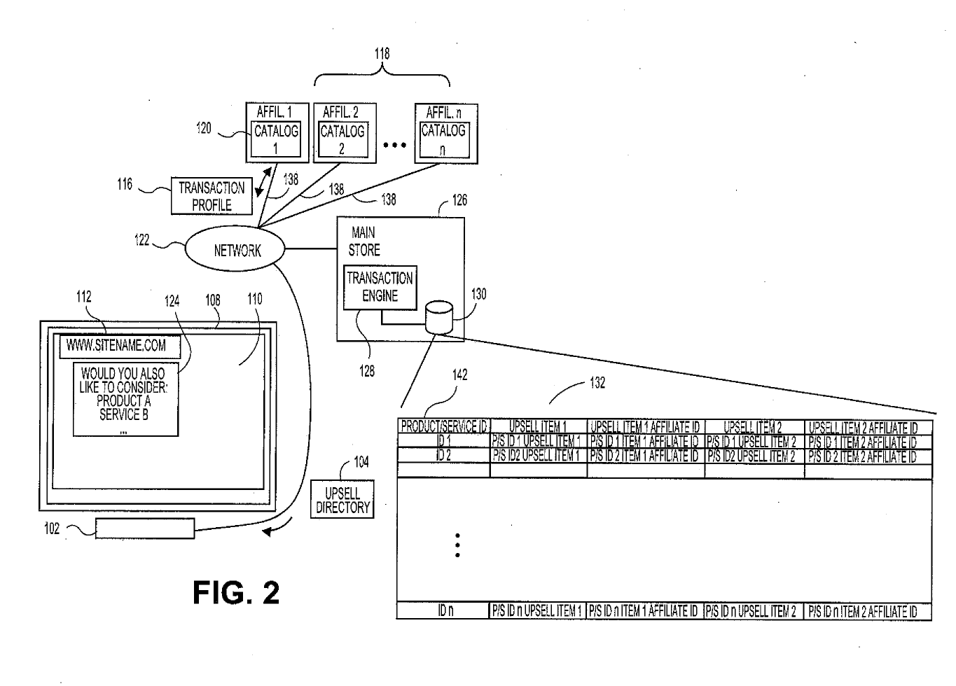

More particularly, as illustrated in FIG. 2, main store 126 can maintain an aggregate upsell catalog 132 containing products/services from the affiliate catalog 120 of each participating affiliate in the set of affiliates. Aggregate upsell catalog 132 can be or include a table of products/services whose rows are indexed by a product/service ID 142. Upon receipt of a transaction profile 116 from an initiating affiliate and/or client 102, transaction engine 128 can process transaction profile 116 to identify products and/or services that the user has selected for purchase. Transaction engine 128 can compare the selected products/services to the product/service ID 142 indexed in aggregate upsell catalog 132 to identify a set of matching upsell recommendations.

Transaction engine 128 can aggregate the upsell recommendations from all available products/services contained in the affiliate catalog 120 of all participating affiliates in the set of affiliates 118. In embodiments, the upsell recommendations associated with a given product/service ID 142 can be generated by aggregating completed prior transactions including the subject product/service ID 142, and sorting those additional products/services that have been most frequently purchased along with the product/service ID 142 in the past. Prior transaction data can for example be extracted from the stored transaction profile 116 of prior transactions.

In embodiments, the upsell recommendations can be generated by inspecting each affiliate catalog 120 associated with the set of affiliates 118 to determine all other products/services residing in the same affiliate catalog 120 as the given product/service ID 142. The combined data can be sorted to identify the additional products/services that are most frequently paired with product/service ID 142 across all catalogs. In embodiments, this can be used to establish a correlation between purchased and additional products/services as upsell recommendations, as evidenced by the product placement selections in the set of affiliates 118. In embodiments, the transaction engine 128 can identify product pairings taking vendor category assignments into account, so that those products/services that are most frequently paired in the same category as product/service ID 142 can be added as upsell recommendations.

In embodiments, the set of upsell recommendations associated with a given product/service ID 142 can be generated and/or modified using the record of user responses to prior upsell recommendations generated by transaction engine 128. For example, the products/services that have in the past most frequently been accepted by users in the past for the same or related products/services can be added to the set of upsell recommendations for products/service ID 142, while products/services having the least selection rate in prior transactions can be removed from the set of upsell recommendations. In embodiments, any one or more of the foregoing upsell identification techniques can be combined to populate recommended products and/or services in aggregate upsell catalog 132. In embodiments, transaction engine 128 can apply thresholds to determine those products/services which will qualify as recommended upsells, such as, e.g., those products/services having a prior acceptance rate of 50% or greater, or other threshold or criteria. In embodiments, transaction engine 128 can limit the number of recommended products/services to be incorporated in upsell directory 140, such as limiting the products/services to the top five recommendations, or other number or limit.

According to embodiments, a user whose transaction profile 116 indicates the purchase of a printer, for example, can result in the identification of a set of upsell recommendations including printer cartridges, printer software, paper products, or warranties or other services in aggregate upsell catalog 132. Upsell directory 140 can thereby be generated by transaction engine 128 based on matches to product/service ID 142 in aggregate upsell catalog 132, and transmitted back to client 102. The recommended options can be presented to the user via upsell dialog 124. The user can accept any of the suggestions or recommendations from upsell dialog 124, and select further products/services for incorporation in the pending purchase.

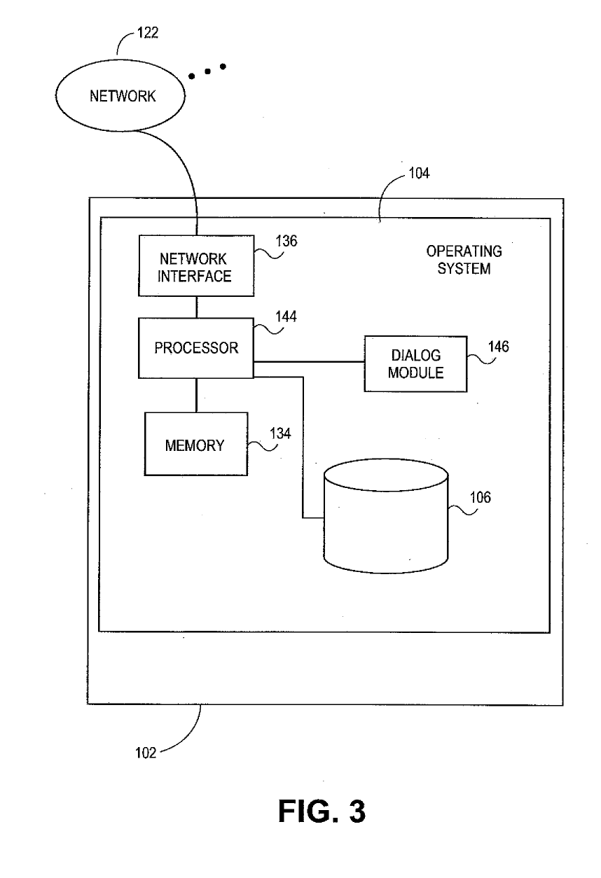

FIG. 3 illustrates an illustrative configuration of hardware and other resources incorporated in client 102, according to embodiments. In embodiments as shown, client 102 can comprise a processor 144 communicating with memory 134, such as electronic random access memory, operating under control of or in conjunction with operating system 104. Processor 144 also communicates with data store 106 (see, e.g., FIG. 1), which can store transaction profile 116 and other data, as well as dialog module 146 that can, for instance, generate and present upsell dialog 124 (see, e.g., FIG. 1) and/or other user dialogs. Processor 120 further communicates with network interface 136, such as an Ethernet or wireless data connection, which in turn communicates with network 122, such as the Internet or other public or private networks, to communicate with the set of affiliates 118 and main store 126. Other configurations of client 102, associated networked connections, and other hardware and software resources, are possible.

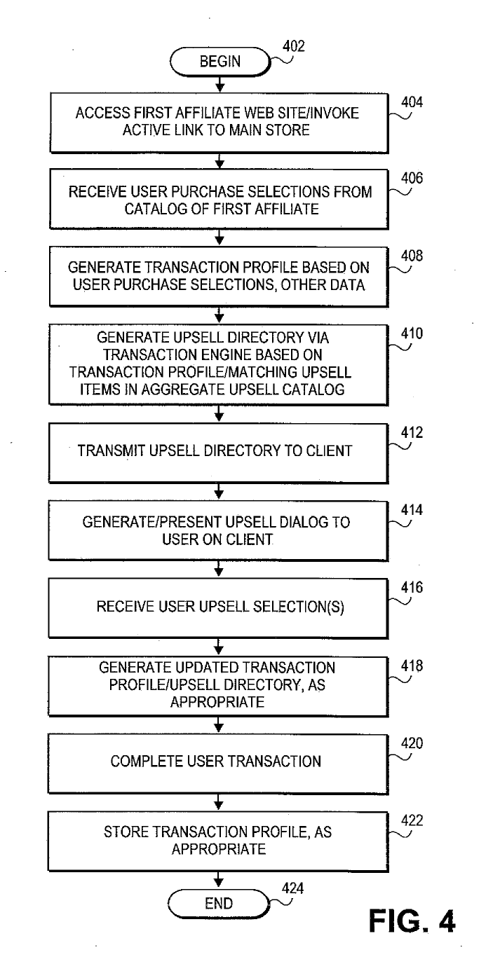

FIG. 4 illustrates a flowchart of overall upsell directory processing across multiple affiliate catalogs, according to various embodiments. In step 402, processing can begin. In step 404, a user can access a first affiliate within a set of affiliates 118, for instance by navigating to a Web site for that affiliate via browser 1 10. The first affiliate accessed by the user can maintain an active link 138 to a main store 126, such as a software distributor, a hardware vendor, or other entity. In step 406, the users purchase selections from the first affiliate in the set of affiliates 118 can be received at the first affiliate Web site through a purchase dialog 114, and communicated to main store 126.

In step 408, main store 126 can generate a transaction profile 116 based on the users purchase selections. Transaction profile 116 can record for example the complete set of products and/or services the user is attempting to purchase from the first affiliate. In embodiments, the transaction profile 116 can record other data, such as the time, date, Web site address, promotional discounts or codes, sales tax information, or other data related to the transaction event. In step 410, transaction engine 128 of main store 126 generates an upsell directory 140 based on transaction profile 116. In embodiments, transaction engine 128 for example can extract a purchase item ID 142 from transaction profile 116 and associate that identifier with matching entries in an aggregate upsell catalog 132 located in main store 126. The entries in aggregate upsell catalog 132 are drawn from the affiliate catalog 120 of not just the first affiliate from which the users transaction is initiated, but the affiliate catalog of all participating affiliates in the set of affiliates 118 The upsell directory 140 therefore identifies further products and/or services that may be of interest to the user across multiple source catalogs. For instance for a user purchasing a printer, the product/service ID 142 can be matched to further entries such as printer cartridges from other hardware catalogs, printer drivers from software catalogs, warranty services from a warranty catalog, or other products or services extracted from multiple catalogs maintained by different affiliates in the set of affiliates 118.

In step 412, upsell directory 140 can be transmitted to client 102 via network 122, for instance via the Internet. In step 414, the user of client 102 can be presented with upsell dialog 124 which enumerates products and services from upsell directory 140 for further selection and purchase, if the user desires. In step 416, any user upsell selections can be received from client 102 and transmitted to main store 126. In embodiments the selection of a product or service from upsell dialog 124 which is hosted in another affiliate can cause browser 110 to navigate to that affiliate's storefront or Web site to retrieve the further products or services.

In step 418, main store 126 can generate an updated transaction profile 116 and/or upsell directory 140 (incorporating upsell suggestions to the newly added purchase items), as appropriate. Further upsell selections can be presented and selected as desired. In step 420, the user's finalized purchase transaction can be completed, for instance by main store 126 or by a participating affiliate in the set of affiliates 118. In step 422, the complete transaction profile 116 can be stored, for instance to main data store 130 of main store 126. In step 424, processing can repeat, return to a prior processing point, jump to a further processing point, or end, as understood by persons skilled in the art.

The foregoing description is illustrative, and variations in configuration and implementation may occur to persons skilled in the art. For example, while embodiments have been described in which a single main store 130 manages the identification of combined upsell matches in the set of affiliates 118, in embodiments more than one primary store can cooperate to manage transactions and generate upsell recommendations. For another example, while embodiments have been described in which the user initiates or engages in a purchase transaction, in embodiments other types of transactions can be completed. For instance the user can initiate a subscription transaction, a lease or rental (e.g., of hardware) transaction, or other type of transaction. For still another example, while embodiments have been described in which logic controlling the upsell processing has been hosted in a transaction engine 128 located in main store 126, in embodiments transaction engine 128 or other logic supporting upsell operations can be hosted in client 102, in an affiliate in the set of affiliates 118, or in other resources or locations. For further example, while embodiments have been described in which the transaction profile 116 generally contains a record of an immediate transaction conducted by the user of client 102, in embodiments transaction profile 116 can store records of one or more prior transactions, and upsell recommendations can be based on both the present and/or prior transaction events. Other resources described as singular or integrated can in embodiments be plural or distributed, and resources described as multiple or distributed can in embodiments be combined. The scope of the invention is accordingly intended to be limited only by the following claims.

What is claimed is:

1. A method of generating an electronic upsell directory, comprising:
receiving a transaction profile of a user transaction initiated at one of a set of affiliates affiliated with at least one main store, each affiliate having a respective affiliate catalog, the transaction profile comprising a product and/or service ID;
generating an aggregate upsell catalog based on the affiliate catalogs of the set of affiliates;
identifying matches between the product and/or service ID and entries in the aggregate upsell catalog; and
generating an upsell directory based on upsell products and/or services associated with the matches.

2. The method of claim 1, wherein each affiliate catalog is derived at least in part from a catalog of the at least one main store.

3. The method of claim 2, wherein each affiliate catalog comprises at least one of hardware products, software products, and services.

4. The method of claim 1, wherein each affiliate comprises a Web site.

5. The method of claim 4, wherein the Web site comprises a storefront.

6. The method of claim 5, wherein each storefront maintains an active link with the at least one main store.

7. The method of claim 1, further comprising presenting an upsell dialog to the user initiating the user transaction based on the upsell directory.

8. The method of claim 7, further comprising repeating the step of generating an upsell directory based on user selections from the upsell dialog.

9. The method of claim 8, further comprising updating the transaction profile based on the user selections from the upsell dialog.

10. The method of claim 9, further comprising completing the user transaction based on the transaction profile and the user selections from the upsell dialog.

11. A system for generating an electronic upsell directory, comprising:
a network interface to a set of affiliates affiliated with at least one main store, each affiliate having a respective affiliate catalog; and
a transaction engine, communicating with the network interface, the transaction engine being configured to
generate an aggregate upsell catalog based on the affiliate catalogs of the set of affiliates,
receive a transaction profile of a user transaction initiated at one of the set of affiliates, the transaction profile comprising a product and/or service ID,
identify matches between the product and/or service ID and entries in the aggregate upsell catalog, and
generate an upsell directory based on upsell products and/or services associated with the matches.

12. The system of claim 11, wherein each affiliate catalog is derived at least in part from a catalog of the at least one main store.

13. The system of claim 12, wherein each affiliate catalog comprises at least one of hardware products, software products, and services.

14. The system of claim 11, wherein each affiliate comprises a Web site.

15. The system of claim 14, wherein the Web site comprises a storefront.

16. The system of claim 15, wherein each storefront maintains an active link with the at least one main store.

17. The system of claim 11, wherein a client communicating with one of the set of affiliates presents an upsell dialog to the user initiating the user transaction based on the upsell directory.

18. The system of claim 17, wherein the transaction engine repeats the generating an upsell directory based on user selections from the upsell dialog.

19. The system of claim 18, wherein the transaction engine updates the transaction profile based on the user selections from the upsell dialog.

20. The system of claim 19, wherein the transaction engine completes the user transaction based on the transaction profile and the user selections from the upsell dialog.

21. An electronic upsell directory, the electronic upsell directory being generated according to a method of:
receiving a transaction profile of a user transaction initiated at one of a set of affiliates affiliated with at least one main store, each affiliate having a respective affiliate catalog, the transaction profile comprising a product and/or service ID;
generating an aggregate upsell catalog based on the affiliate catalogs of the set of affiliates;
identifying matches between the product and/or service ID and entries in the aggregate upsell catalog; and
generating an upsell directory based on upsell products and/or services associated with the matches.

22. The electronic upsell directory of claim 21, wherein each affiliate catalog is derived at least in part from a catalog of the at least one main store.

23. The electronic upsell directory of claim 22, wherein each affiliate catalog comprises at least one of hardware products, software products, and services.

24. The electronic upsell directory of claim 21, wherein each affiliate comprises a Web site.

25. The electronic upsell directory of claim 24, wherein the Web site comprises a storefront.

26. The electronic upsell directory of claim 25, wherein each storefront maintains an active link with the at least one main store.
